(19) United States
(12) Patent Application Publication
(10) Pub. No.: US 2013/0204706 A1
(43) Pub. Date: Aug. 8, 2013

(54) TARGETING CONTENT TO USERS AT A DISTANCE FROM A LOCATION

(71) Applicants: Xinyu Tang, Cupertino, CA (US); Charles Chapin, San Jose, CA (US)

(72) Inventors: Xinyu Tang, Cupertino, CA (US); Charles Chapin, San Jose, CA (US)

(73) Assignee: Google Inc.

(21) Appl. No.: 13/369,185

(22) Filed: Feb. 8, 2012

(51) Int. Cl. G06Q 30/02; G06Q 30/08

(52) U.S. Cl. 705/14.58

(57) ABSTRACT

Methods, systems, and apparatus, including computer programs encoded on a computer-readable storage medium, and including a method for providing a content item. The method comprises receiving a request for a content item, identifying one or more content items responsive to the request, where at least one of the content items includes targeting criteria that is based at least in part on a location associated with the user. The method further comprises identifying a specified location associated with the one content item, identifying a current location of the user, and determining a distance from the current location to the specified location. The method further comprises determining when the distance satisfies the targeting criteria associated with the one content item and, when the distance satisfies the targeting criteria, including the one content item in an auction along with other content items, and providing winning results of the auction responsive to the request.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Content item slots can be allocated to content as part of a reservation system, or in an auction. For example, content sponsors can provide bids specifying amounts that the sponsors are respectively willing to pay for presentation of their content. In turn, an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a computer-implemented method for providing content. The method comprises receiving a request for a content item to be served to a user. The method further comprises identifying, using one or more computing devices, one or more content items responsive to the request, where at least one of the content items includes targeting criteria that is based at least in part on a location associated with the user. The method further comprises identifying a specified location associated with the one content item. The method further comprises identifying a current location of the user. The method further comprises determining a distance from the current location to the specified location. The method further comprises determining, using the one or more computing devices, when the distance satisfies the targeting criteria associated with the one content item and, when the distance satisfies the targeting criteria, including the one content item in an auction along with other content items responsive to the request. The method further comprises providing winning results of the auction responsive to the request.

These and other implementations can each optionally include one or more of the following features. The content item can be an advertisement. The location can be a geographic location. The location can be a geographic feature. The location can be a point. The location can be a feature and can correspond to a city, a metropolitan area, a county, a state, a region or a country and the distance can be a distance from a boundary associated with the feature.

In general, another innovative aspect of the subject matter described in this specification can be implemented in methods that include a computer-implemented method for delivering content. The method comprises receiving an indication from a content sponsor to create a campaign for presenting content to one or more users responsive to received requests to deliver content. The method further comprises receiving, using one or more computing devices, targeting criteria for the campaign including receiving an indication to target content based at least in part on one or more distances of a user from a geographic location associated with the campaign, the targeting criteria including one or more bids for the presentation of content associated with the geographic location, the presentation of the content to occur in response to a request for content from a particular user and when a current location of the particular user is within a certain distance relative to the geographic location. The method further comprises storing the campaign. The method further comprises delivering, using the one or more computing devices, the content to users in accordance with the campaign and responsive to requests for content received from a user with a current location within the certain distance relative to the geographic location.

These and other implementations can each optionally include one or more of the following features. The one or more bids can include different bids on plural different distances.

In general, another innovative aspect of the subject matter described in this specification can be implemented in methods that include a computer-implemented method for delivering content. The method comprises receiving a request for a content item to be served to a user. The method further comprises identifying, using one or more computing devices, a content item from an inventory of content items that is responsive to the request, where the content item is associated with targeting criteria that is based on a location associated with the user. The method further comprises identifying a specified location associated with the content item. The method further comprises identifying a current location of the user. The method further comprises determining a distance from the current location to the specified location. The method further comprises determining, using the one or more computing devices, when the distance satisfies the targeting criteria associated with the content item and, when the distance satisfies the targeting criteria, including the one content item as an eligible content item for providing content responsive to the received request.

These and other implementations can each optionally include one or more of the following features. The content item can be an advertisement. Identifying the specified location can include defining the specified location using a feature selected from the group comprising a point, a building, an address, a ZIP code, a city, a county, a state or a user-defined polygon. The method can further comprise conducting an auction including the content item and other eligible content items. Including can further comprise serving the content item responsive to the request. Including can further comprise evaluating the content item along with one or more eligible content items using a selection process. The selection process can be an auction. The selection process can be a reservation service.

In general, another innovative aspect of the subject matter described in this specification can be implemented in systems that include a system for providing content items. The system comprises a sponsor interface that allows a content sponsor to target a content item to users, where the content item is associated with targeting criteria that is based on a location associated with the users and further based on a specified location associated with the content item. The system further comprises a content management system that provides content items responsive to received requests, the content management system comprising a request handler. The request handler is enabled to receive a request for content from a user, identify a current location of the user, determine a distance from the current location to the specified location, determine when the distance satisfies the targeting criteria associated with the one content item and, when the distance satisfies the targeting criteria, including the one content item in an auction along with other content items responsive to the request, and provide winning results of the auction responsive to the request.

In general, another innovative aspect of the subject matter described in this specification can be implemented in computer program products that include a computer program product tangibly embodied in a computer-readable storage device and comprising instructions. The instructions, when executed by a processor, cause the processor to: receive a request for a content item to be served to a user, identify one or more content items responsive to the request, where at least one of the content items includes a targeting criteria that is based at least in part on a location associated with the user, identify a specified location associated with the one content item, identify a current location of the user, determine a distance from the current location to the specified location, determine when the distance satisfies the targeting criteria associated with the one content item and, when the distance satisfies the targeting criteria, including the one content item in an auction along with other content items responsive to the request, and provide winning results of the auction responsive to the request.

In general, another innovative aspect of the subject matter described in this specification can be implemented in computer program products that include a computer program product tangibly embodied in a computer-readable storage device and comprising instructions. The instructions, when executed by a processor, cause the processor to: receive an indication from a content sponsor to create a campaign for presenting content to one or more users responsive to received requests to deliver content, receive targeting criteria for the campaign including receiving an indication to target content based at least in part on one or more distances of a user from a geographic location associated with the campaign, the targeting criteria including one or more bids for the presentation of content associated with the geographic location, the presentation of the content to occur in response to a request for content from a particular user and when a current location of the particular user is within a certain distance relative to the geographic location, store the campaign, and deliver the content to users in accordance with the campaign and responsive to requests for content received from a user with a current location within the certain distance relative to the geographic location.

In general, another innovative aspect of the subject matter described in this specification can be implemented in computer program products that include a computer program product tangibly embodied in a computer-readable storage device and comprising instructions. The instructions, when executed by a processor, cause the processor to: receive a request for a content item to be served to a user, identify a content item from an inventory of content items that is responsive to the request, where the content item is associated with targeting criteria that is based on a location associated with the user, identify a specified location associated with the content item, identify a current location of the user, determine a distance from the current location to the specified location, and determine when the distance satisfies the targeting criteria associated with the content item and, when the distance satisfies the targeting criteria, including the one content item as an eligible content item for providing content responsive to the received request.

Particular implementations may realize none, one or more of the following advantages. Content sponsors may be willing to bid higher for impressions of their content if the content sponsors have control over the types of users who are targeted, including users who are targeted based on a distance between their current location and the geographic location associated with the content item.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIGS. 2A and 2B collectively show an example system for targeting and providing content to users based on location-distance targeting criteria.

FIG. 3A is a flowchart of an example process for targeting content using location-distance targeting criteria.

FIGS. 3B and 3C are flowcharts of example processes for serving content using location-distance targeting criteria.

FIG. 4 is a block diagram of an example computer system that can be used to implement the methods, systems and processes described in this disclosure.

Like reference numbers and designations in the various drawings indicate like elements.

### DETAILED DESCRIPTION

Content sponsors, for example, can target content to users based on their current location relative to a location associated with a content item (e.g., an advertisement). For example, a content sponsor C can submit offers (e.g., bids for use in an auction or an offer that is part of a reservation, hereinafter collectively referred to as an “offer”) for subsequent impressions of advertisements in a campaign that is targeted to users within one or more specified distances from a target location. The offers can depend, for example, on whether users to whom the content is to be presented are currently at a location within the distance(s) specified in the targeting criteria. Consequently, when content is requested for a particular user (e.g., to fill an advertisement slot on a web page or in a browser), the user's current location can be determined, and corresponding offers for content can be identified (e.g., from offers made by the content sponsor C and other content sponsors). For example, if the user's current location satisfies the distance criteria associated with the offer, then the bid for the content item can be identified. Depending on the terms of the offer, the content item associated with the content sponsor C can be provided in response to the request for content.

A location, for example, can be a geographic location, (e.g., latitude/longitude coordinates), a point (e.g., an address) or a geographic feature that corresponds to a city, a metropolitan area, a county, a state, a region or a country. Distances between a user's location and a feature can be determined, for example, based on a point that represents the feature or based on a boundary associated with the feature. For example, distances can be determined relative to an address of a hotel or business (e.g., represented as a point) or relative to the boundary of a city, metropolitan area, county, state, region or country (e.g., represented as a perimeter, polygon or other shape).

In one example scenario in which location-distance targeting can be used, consider an advertiser who has a hotel in San Francisco. For example, because of the location of the hotel, the advertiser may want advertisements associated with the hotel to be targeted to users who are a certain distance from the hotel and may be likely to need hotel accommodations when traveling to San Francisco. Ads for the hotel can be targeted to users who, for example, submit queries associated with San Francisco and whose current locations are far away (e.g., over 1000 miles). For example, the queries may signal an intent to visit San Francisco, a trip that may require a hotel room. This can provide the content sponsor with an opportunity to target users who may be more likely to engage with the content (e.g., an ad for the San Francisco hotel).

In another example, a user in New York City may be running a map application that displays the San Francisco area, or the user may have a San Francisco business listing displayed (e.g., after submitting a query in a browser). Because the user's location of interest is far away (e.g., more than 1000 miles) from the user's current location, it may be likely that the user plans to travel to San Francisco. In this example, content sponsors (e.g., advertisers) who are hotel owners or airline ticket agencies may want to pay more to show their advertisements to remote users.

In yet another example, users in Northern California may have business listings (e.g., evening shows in the Mission District) displayed in a web browser. While the users may not be interested in flying to San Francisco, they are also unlikely to drive home after the show. In this example, content sponsors may want to target the users for hotel-related advertisements, e.g., using a targeting distance that may require a hotel stay but no air travel.

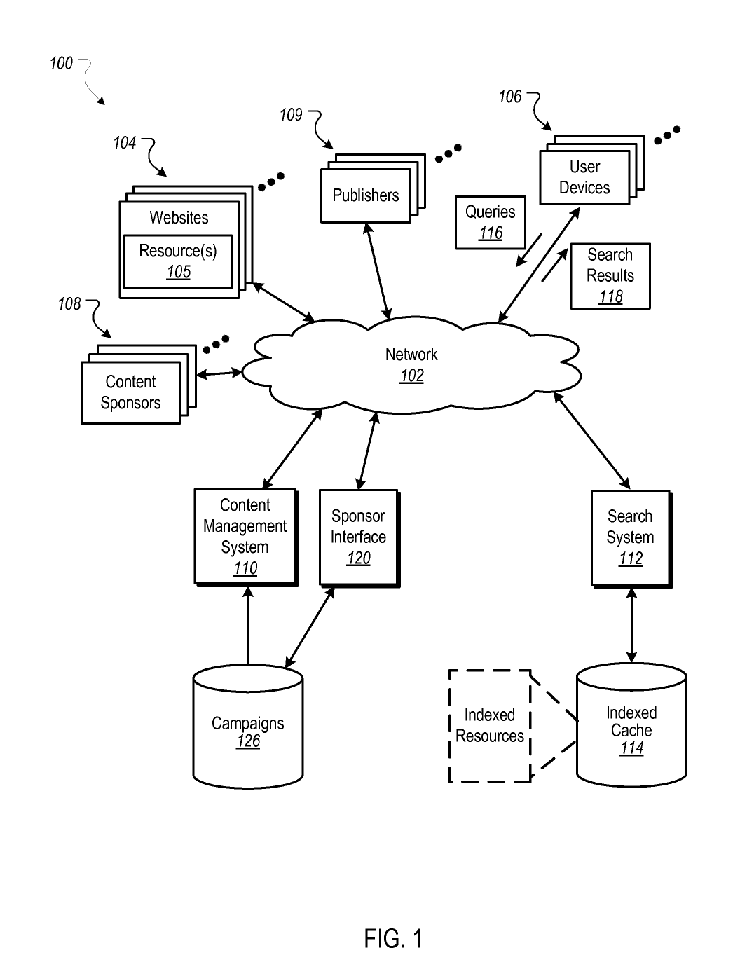

FIG. 1 is a block diagram of an example environment 100 for delivering content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), content publishers 109, and the content management system 110. The example environment 100 may include many thousands of websites 104, user devices 106, content sponsors 108 and content publishers 109.

In some implementations, the environment 100 can include plural data stores that are used in various stages to target and deliver content based on location-distance targeting. For example, a data store of campaigns 126 can store campaigns that are created by content sponsors 108, e.g., using the sponsor interface 120. For example, the campaigns 126 can include targeting criteria specified by content sponsors 108 to target content to users based at least in part on location-distance targeting. By way of example, location-distance targeting can include targeting of content based at least in part on the distance between the current location of a user and the geographic location associated with a content item.

In some implementations, the content management system 110 includes a request handler that can receive a request for content from a user, identify one or more eligible content items, and provide a content item responsive to the request. More specifically, the request handler can determine, for campaigns 126 that include location-distance targeting criteria, if the user who provided the request for content has a current location within a specified distance from the location associated with the content item.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript scripts).

A user device 106 is an electronic device that is under control of a user and is capable of requesting and receiving resources over the network 102. Example user devices 106 include personal computers, televisions, set-top boxes, mobile communication devices (e.g., smartphones), and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or web page, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. In some implementations, the content management system 110 can generate search results 118 using information (e.g., identified resources) received from the search system 112. An example search result 118 can include a web page title, a snippet of text or a portion of an image extracted from the web page, and the URL of the web page. Search results pages can also include one or more slots in which other content items (e.g., ads) can be presented. In some implementations, slots on search results pages or other web pages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation) and information related to location-distance targeting.

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations). The offers represent the amounts that the content sponsors are willing to pay for presentation (or selection) of their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a web page, and consummates a purchase there before leaving that web page. A conversion can also be defined by a content provider to be any measurable/observable user action, such as downloading a white paper, navigating to at least a given depth of a website, viewing at least a certain number of web pages, spending at least a predetermined amount of time on a web site or web page, registering on a website, experiencing media, or performing a social action regarding a content item (e.g., an ad), such as republishing or sharing the content item. Other actions that constitute a conversion can also be used.

In some implementations, the likelihood that a conversion will occur can be improved, such as by serving content that is more likely to be of interest to the user. For example, content items (e.g., ads) that are served can be selected in part based on location-distance targeting, which can also be an indication of how likely the user is to react positively to a content item, e.g., leading to a conversion.

For situations in which the systems discussed here collect location information about users, the users may be provided with an opportunity to opt in/out of programs or features that may collect location information or use the information to target content. In addition, certain data may be anonymized in one or more ways before it is stored or used, so that personally identifiable information is removed. For example, a user's identity may be anonymized so that no personally identifiable information can be determined for the user. Moreover, a user's geographic location may be generalized so that, for example, when location information is obtained (such as a city, ZIP code or state), a particular location of a user cannot be determined.

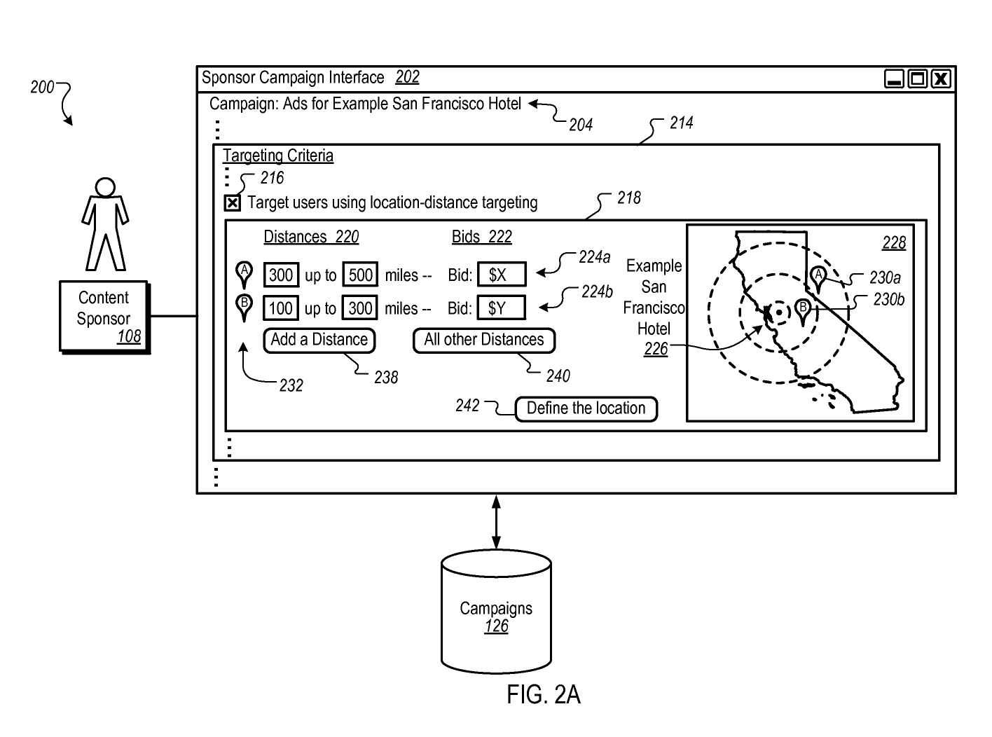

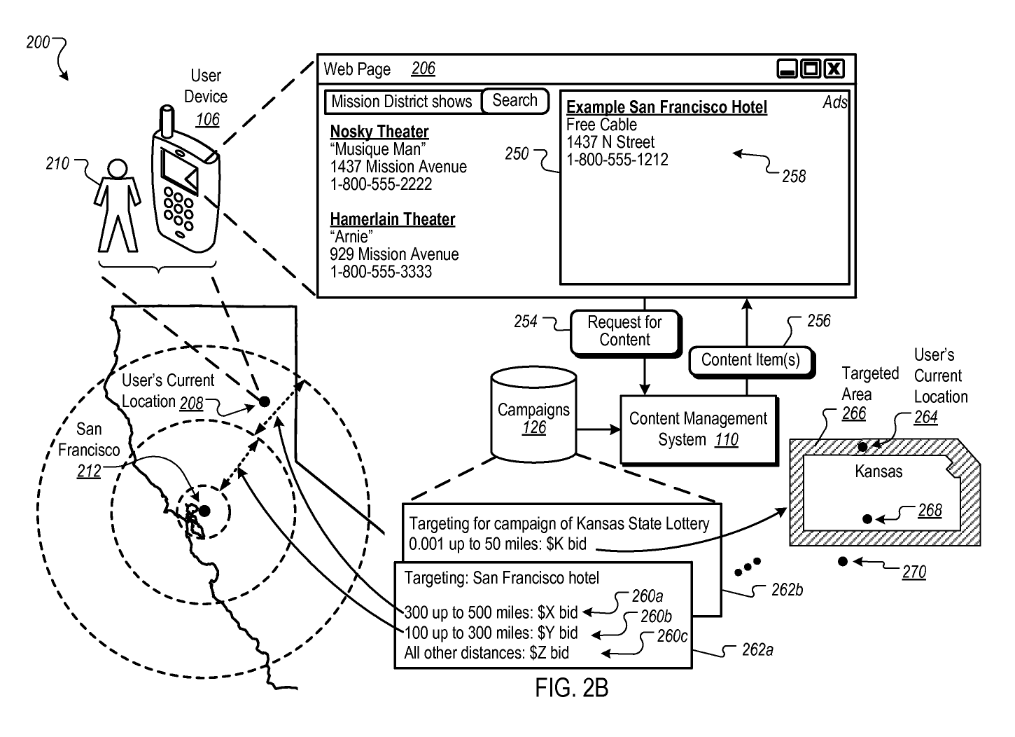

FIGS. 2A and 2B collectively show an example system 200 for targeting and providing content to users based on location-distance targeting criteria. FIG. 2A, for instance, shows an example campaign sponsor interface 202 for specifying targeting criteria for a campaign 204 that includes advertisements for an Example San Francisco Hotel. The targeting criteria, for example, can be used to target advertisements to users based on the distance between the users' current locations and the location associated with the Example San Francisco Hotel. In some implementations, the sponsor interface 120 can provide the campaign sponsor interface 202 and/or other interfaces for targeting content to users based on location-distance targeting.

FIG. 2B shows an example user interface 206 in which targeted content is provided based on a current location 208 of a user 210. As will be described in more detail below, the user interface 206 is one example of how the system 200 can provide targeted content based at least in part on the user's current location relative to a San Francisco location 212 associated with a content item. For example, advertisements from the content sponsor's advertising campaign (e.g., campaigns 126) can be provided in response to received requests to deliver content to the user interface 206.

Referring again to FIG. 2A, in some implementations, the campaign sponsor interface 202 can include a targeting criteria area 214 from which the content sponsor 108 can select targeting parameters for a campaign. For example, the targeting criteria area 214 can be one of multiple areas within the campaign sponsor interface 202. In some implementations, the targeting criteria area 214 can include one or more controls for receiving an indication from the content sponsor 108 to target users using location-distance targeting. The location-distance targeting, for example, can be based on users' current locations (e.g., at content-serving time) relative to the location associated with the content item (e.g., the address of the Example San Francisco Hotel).

In some implementations, the content sponsor 108 can select a location-distance targeting option 216, e.g., by checking a “Target users using location-distance targeting” checkbox. For example, selection of the location-distance targeting option 216 can result in the presentation and/or availability of an options area 218.

The options area 218 can include various controls and displays including, e.g., distances 220 and bids 222. For example, the each bid 222 can represent the amount that the content sponsor 108 is willing to pay (e.g., per 1,000 impressions) for impressions of content of the campaign 204 to users whose current locations are within the distance 220. In some implementations, distances can be represented using a range. For example, as shown in FIG. 2A, entry 224a includes a bid 222 of $X for impressions of content to users whose current locations exceed 300 miles and are up to 500 miles from a geographic location 226 (e.g., the address of the Example San Francisco Hotel). Entry 224b, for example, includes a bid 222 of $Y for impressions of content to users whose current locations exceed 100 miles and are up to 300 miles from the geographic location 226.

In some implementations, the options area 218 can include a map 228 that can be used, for example, to display the geographic location 226 associated with the content item. For example, the map 228 can be a map that includes California that includes the geographic location 226 that is San Francisco. In some implementations, the map 228 can include markers 230a and 230b (e.g., push-pins labeled “A” and “B”), for example, that indicate the positions on the map 228 that correspond to distances 220 associated with the entries 224a and 224b. The markers 230a and 230b can correspond to line-by-line indicators 232 (e.g., also labeled “A” and “B”) that label each of the entries 224a and 224b relative to the map 228.

In some implementations, controls associated with the map 228 can allow the content sponsor 108 to draw or select an area to which to target content. For example, an interface based on a positional marker (e.g., cursor, etc.) on the screen can be used to define a bounding region (e.g., by expanding one or more circles having radius) relative to geographic location 226. Pairs of concentric circles can indicate a range of distances associated with a particular bid. In some implementations, the map 228 can include controls for drawing a user-defined polygon or selecting a point, a building, an address, a ZIP code, a city, a county or a state from the map 228, any of which can also be defined using text input or using selection from a list.

In some implementations, the campaign sponsor interface 202 can include an add distance control 238 that the content sponsor 108 can use, for example, to add another entry similar to the entries 224a and 224b. For example, upon selection of the add distance control 238, a popup (not shown in FIG. 2A) can appear in which the content sponsor can enter a range of distances (e.g., 500 and 800) for yet another separate bid amount. Other ways can be used for entering distances 220 and bids 222 including, for example, tables, arrays and so on.

In some implementations, distances 220 and bids 222 that appear in fields within the options area 218 can be edited directly, e.g., as text-entry fields. In some implementations, distance ranges can be expressed as a minimum distance up to infinity (e.g., “800 miles and beyond”). Other units can be used instead of miles.

In some implementations, a control 240 can be used to create an entry similar to the entries 224a and 224b in order to represent, for example, a bid 222 for the remainder of the distances. For example, after selection of the control 240, the content sponsor 108 can specify $Z for a bid 222 for the remainder of distances not represented by the entries 224a and 224b (e.g., for distances outside of 100-500 miles).

In some implementations, statistics can be presented for each range of distances. For example, one set of statistics can provide an estimate of the number of users who may be targeted for each of the different distance ranges.

In some implementations, the options area 218 can include a location definition control 242, e.g., for use in situations in which the geographic location 226 is not a single point (e.g., the address of the Example San Francisco Hotel). For example, upon selection of the location definition control 242 by the content sponsor 108, a popup or other controls can appear by which the user can specify a location associated with the campaign 204. Example locations include a city, county, state, ZIP code, or any user-defined polygon.

Referring to FIG. 2B, the user interface 206 can be, for example, a web page or some other interface (e.g., a web browser) that the user 210 is using on the user device 106. The user interface 206 can include one or more content item slots 250, e.g., for displaying advertisements. To fill the content item slots 250, for example, the user interface 206 can provide a request for content 254 that is received by the content management system 110. Upon receipt of the request for content 254, the content management system 110 can provide one or more content items 256 that are responsive to the request, as described above. As an example, the content items 256 that are provided can be selected based at least in part on location-distance targeting described with reference to FIG. 2A.

The user 210 for which the request for content 254 occurs can be physically situated at the current location 208, e.g. somewhere in Northern California. For example, the user's location can be determined using global positioning system (GPS) capabilities of the user's mobile device, or based on an address voluntarily provided by the user, e.g., in a profile for a non-mobile computer. Upon receipt of the request for content 254, the content management system 110 can access information in the campaigns 126 to identify content items that are responsive to the request. Some campaigns 126, for example, can include location-distance targeting, as described above with reference to FIG. 2A. Other campaigns 126 can be campaigns that do not use location-distance targeting. As a result, campaigns 126 that are selected to identify eligible content items responsive to the request for content 254 can include both types of targeting, e.g., resulting from campaigns with and without location-distance targeting.

Eligible content items that do include location-distance targeting can be identified, for example, by the content management system 110 in the following way. For example, for the campaign 204 defined for content items related to the Example San Francisco Hotel, location-distance targeting parameters 260a-260c can be accessed from the campaigns 126. The user's current location 208 can be compared against the distance ranges identified by the location-distance targeting parameters 260a-260c. For example, the user's current location 208 (e.g., 400 miles from the San Francisco location 212) can be determined to fall within the distance range of 300-500 miles identified by the location-distance targeting parameters 260b. As a result, a content item associated with the campaign 204 can be identified as an eligible content item, as can other content items that also meet the targeting requirements of the content item slot 250.

In some implementations, the one or more eligible content items 256 can be evaluated by conducting an auction. For example, the auction can include one or more bids associated with the content sponsors 108 that elected to target users using location-distance targeting described with reference to FIG. 2A. As a result, the content items 256 that are provided can be based at least in part on the auction and the location-distance information, as well as other information that can typically be used for selecting content items, e.g., including the relevance of content items to keywords, or criteria for selecting content to fulfill reservations, to name a few examples.

In another example, consider targeting for a Kansas State Lottery advertising campaign that includes advertisements targeted to nearby non-residents in neighboring states. For example, the campaign can include location-distance targeting parameters 262b that include a $K bid for 1000 impressions to users whose current location 264 is within a 50-mile-wide targeted zone 266 that surrounds Kansas. For example, the targeted zone 266 can be calculated automatically by the campaign sponsor interface 202 after the content sponsor 108 associated with the campaign selects Kansas (e.g., from a list of states) after selecting the location definition control 242. The location-distance targeting parameters 262b can be used, for example, when a user who lives in Nebraska, five miles across the border with Kansas, is running a web browser. In response to a request for content 254 to fill a content item slot in the user's browser, the content management system 110 can determine that the user's current location 264 falls within the targeted range (e.g., 0.001 to 50 miles), and an ad related to the Kansas State Lottery can be provided as the content item 256. The location-distance targeting parameters 262b can prevent the Kansas State Lottery advertisement from reaching users who are not in the targeted zone 266. For example, the advertisement may not be provided to a user at a location 268 inside Kansas (e.g., if the range excludes those inside the state) or a user at a location 270 that is more than 50 miles from the Kansas border.

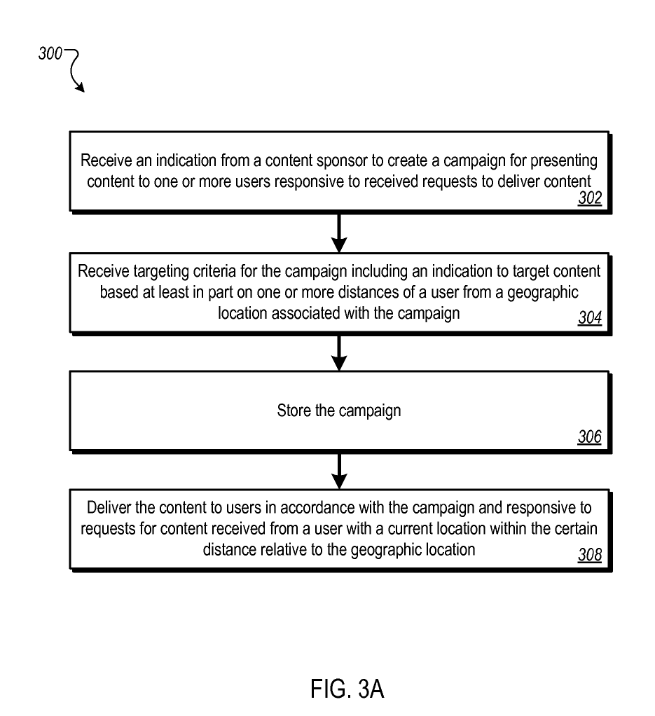

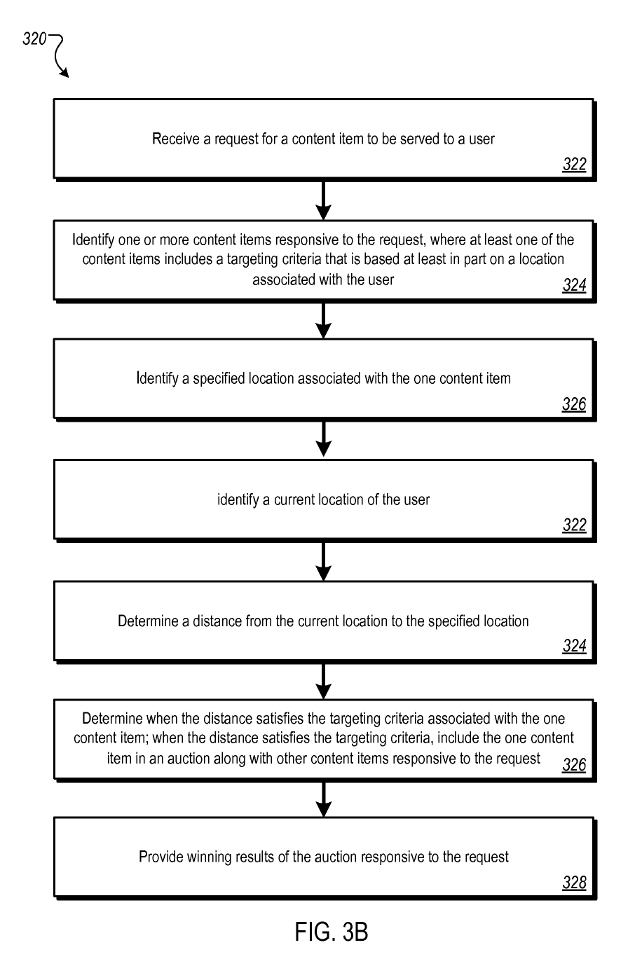

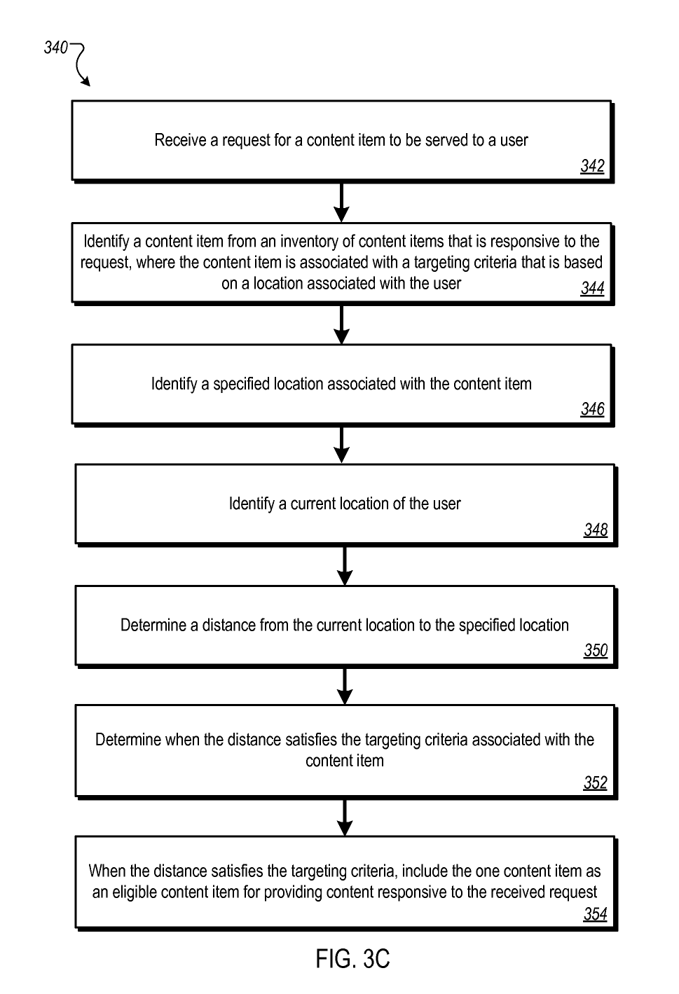

FIG. 3A is a flowchart of an example process 300 for targeting content using location-distance targeting criteria. Specifically, the targeting is based, at least in part, on the distance between a user's current location and the location associated with a content item. The process 300 can be performed, for example, by the content management system 110. FIGS. 2A-2B are used to provide examples for steps of the process 300.

An indication is received from a content sponsor to create or modify a campaign for presenting content to one or more users responsive to received requests to deliver content (302). For example, the content sponsor 108 can use controls in the campaign sponsor interface 202 to create or select a campaign 204 (such as one that includes advertisements for an Example San Francisco Hotel). The selection of the campaign 204, for example, can be to define the targeting parameters, including location-distance targeting parameters. Parameters can be defined for a new campaign or can be modified for an existing campaign.

Targeting criteria for the campaign is received, including receiving an indication to target content based at least in part on one or more distances of a user from a geographic location associated with the campaign (304). The targeting criteria includes one or more bids for the presentation of content associated with the geographic location. The presentation of the content is to occur in response to a request for content from a particular user and when a current location of the particular user is within a certain distance relative to the geographic location. For example, the content sponsor 108 can use the campaign sponsor interface 202 as described above. Specifically, the content sponsor 108 can specify one or more distances (e.g., ranges of distances) and bids corresponding to the distances. For example, the one or more bids (e.g., $X and $Y) can include different bids on plural different distances (e.g., 100-300 miles, and 300-500 miles). The distances can be relative to a point (e.g., the address of a store), a named entity (e.g., a city, state, ZIP code, etc.), or a user-defined polygon.

In some implementations, the geographic location to be associated with the campaign is provided or determined. For example, the user may be prompted to provide the geographic location (e.g., the address of the Example San Francisco Hotel). Alternatively, another form of location (a city, county, metro, region, state, etc.) can be defined as the geographic location. In some implementations, the location can be inferred. When inferred, the geographic location can be presented to the user for confirmation.

The campaign is stored (306). For example, the campaign sponsor interface 202 can store the targeting information and other campaign information in the campaigns 126.

The content is delivered to users in accordance with the campaign and responsive to requests for content received from a user with a current location within the certain distance relative to the geographic location (308). For example, the content management system 110 can provide one or more content items 256 in response to the request for content 254. The content items selected can include, for example, the selection of the advertisement for the Example San Francisco Hotel. At least in part, the selection can occur because the distance (e.g., 400 miles) of the current location of the user 210 is within the distance range of 300-500 miles from San Francisco, as identified in the location-distance targeting parameters 260b.

In some implementations, the content item 256 that is provided can be based on conducting an auction. The auction can use the one or more bids associated with content sponsors 108, some of which can specify to target content using location-distance targeting. Some bids may include no preference for targeting content using location-distance targeting and can be evaluated along with the bids of content sponsors 108 that do target content using location-distance targeting.

FIG. 3B is a flowchart of an example process 320 for serving content using location-distance targeting criteria. More specifically, the process 320 provides content items based, at least in part, on the distance between a user's current location and the location associated with the content item. The content management system 110, for example, can use one or more computing devices to perform at least some of steps of the process 320. FIG. 2B is used to provide examples for steps of the process 320.

A request is received for a content item to be served to a user (322). For example, the content management system 110 can receive the request for content 354, e.g., to fill the content item slot 250.

One or more content items responsive to the request are identified (324). At least one of the content items includes targeting criteria that is based at least in part on a location associated with the user. For example, the content management system 110 can identify the Example San Francisco Hotel advertisement from the campaign 204.

A specified location associated with the one content item is identified (326). As an example, the content management system 110 can identify the San Francisco location 212 as the location, e.g., by using information in the campaign 204.

A current location of the user is identified (328). For example, the current location (e.g., northeast of the San Francisco location 212) for the user 210 can be identified using GPS or some other location identification technology contained in or associated with the user device 106.

A distance from the current location to the specified location is determined (330). As an example, the content management system 110 can determine that the distance between the user's current location 208 and the San Francisco location 212 is 400 miles.

A determination is made whether the distance satisfies the targeting criteria associated with the one content item (332). When the distance satisfies the targeting criteria, the one content item can be included in an auction along with other eligible content items responsive to the request.

Winning results of the auction are provided responsive to the request (334). For example, if the bid of $Y associated with the location-distance targeting parameters 260b is relatively higher than other bids in the auction (e.g., when multiplied by quality scores or other factors), then the Example San Francisco Hotel advertisement can be the content item that wins the auction and is provided as the content items 256.

FIG. 3C is a flowchart of another example process 340 for serving content using location-distance targeting criteria. More specifically, the process 340 provides content items based, at least in part, on the distance between a user's current location and the location associated with the content item. The content management system 110, for example, can use one or more computing devices to perform at least some of steps of the process 340. FIG. 2B is used to provide examples for steps of the process 340.

A request is received for a content item to be served to a user (342). For example, the content management system 110 can receive the request for content 354, e.g., to fill the content item slot 250.

A content item is identified from an inventory of content items that is responsive to the request (344). The content item is associated with targeting criteria that is based on a location associated with the user. As an example, the content management system 110 can identify one or more eligible content items from campaigns that include location-distance targeting, e.g., including the Example San Francisco Hotel advertisement that is part of the campaign 204.

A specified location associated with the content item is identified (346). For example, the content management system 110 can identify the San Francisco location 212 as the location, e.g., by using information in the campaign 204. In some implementations, identifying the specified location can include defining the specified location using a feature selected from the group comprising a point, a building, an address, a ZIP code, a city, a county, a state or a user-defined polygon.

A current location of the user is identified (348). For example, the current location (e.g., northeast of the San Francisco location 212) for the user 210 can be identified using GPS or some other location identification technology contained in or associated with the user device 106.

A distance from the current location to the specified location is determined (350). As an example, the content management system 110 can determine that the distance between the user's current location 208 and the San Francisco location 212 is 400 miles.

A determination is made whether the distance satisfies the targeting criteria associated with the content item (352). For example, the content management system 110 can determine if a particular campaign 126 includes location-distance targeting that targets a distance (e.g., the range 300-500 miles) that includes the 400 mile distance relative to the current location.

When the distance satisfies the targeting criteria, the one content item is included as an eligible content item for providing content responsive to the received request (354). For example, the content management system 110 can include the Example San Francisco Hotel advertisement with the other eligible content items, any of which can be selected as the content item(s) 256 to be provided in response to the request for content 254.

In some implementations, an auction can be conducted that includes the content item (e.g., selected using location-distance targeting) along with other eligible content items. For example, the content management system 110 can use a selection process, such as an auction or a reservation system, to evaluate the content item along with one or more eligible content items. As a result of the selection process, the content can be served in response to the request for content.

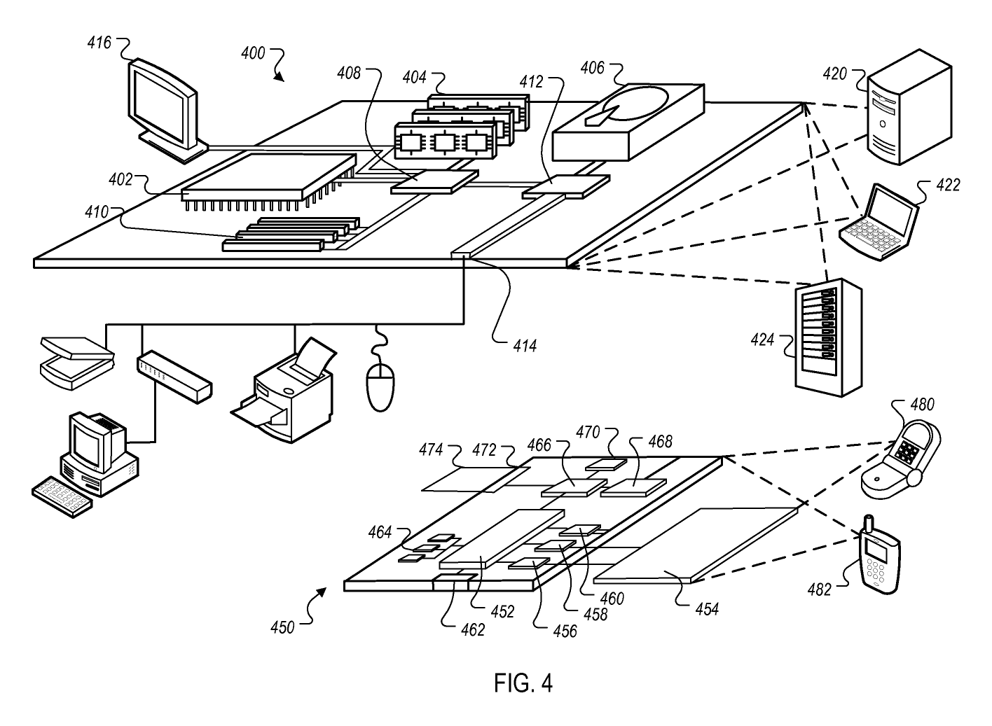

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent various typically non-mobile devices, such as televisions, set-top boxes or other electronic devices with one or more processers embedded therein or attached thereto. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a subscriber identification module (SIM) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a request for a content item to be served to a user;
identifying, using one or more computing devices, one or more content items responsive to the request, where at least one of the content items includes a targeting criteria that is based at least in part on a location associated with the user;
identifying a specified location associated with the one content item;
identifying a current location of the user;
determining a distance from the current location to the specified location;
determining, using the one or more computing devices, when the distance satisfies the targeting criteria associated with the one content item and, when the distance satisfies the targeting criteria, including the one content item in an auction along with other content items responsive to the request; and
providing winning results of the auction responsive to the request.

2. The method of claim 1 wherein the content item is an advertisement.

3. The method of claim 1 wherein the location is a geographic location.

4. The method of claim 1 wherein the location is a geographic feature.

5. The method of claim 1 wherein the location is a point.

6. The method of claim 1 wherein the location is a feature and corresponds to a city, a metropolitan area, a county, a state, a region or a country and the distance is a distance from a boundary associated with the feature.

7. A computer-implemented method comprising:
receiving an indication from a content sponsor to create a campaign for presenting content to one or more users responsive to received requests to deliver content;
receiving, using one or more computing devices, targeting criteria for the campaign including receiving an indication to target content based at least in part on one or more distances of a user from a geographic location associated with the campaign, the targeting criteria including one or more bids for the presentation of content associated with the geographic location, the presentation of the content to occur in response to a request for content from a particular user and when a current location of the particular user is within a certain distance relative to the geographic location;
storing the campaign; and
delivering, using the one or more computing devices, the content to users in accordance with the campaign and responsive to requests for content received from a user with a current location within the certain distance relative to the geographic location.

8. The method of claim 7 wherein the one or more bids include different bids on plural different distances.

9. A computer-implemented method comprising:
receiving a request for a content item to be served to a user;
identifying, using one or more computing devices, a content item from an inventory of content items that is responsive to the request, wherein the content item is associated with targeting criteria that is based on a location associated with the user;
identifying a specified location associated with the content item;
identifying a current location of the user;
determining a distance from the current location to the specified location; and
determining, using the one or more computing devices, when the distance satisfies the targeting criteria associated with the content item and, when the distance satisfies the targeting criteria, including the one content item as an eligible content item for providing content responsive to the received request.

10. The method of claim 9 wherein the content item is an advertisement.

11. The method of claim 9 wherein identifying the specified location includes defining the specified location using a feature selected from the group comprising a point, a building, an address, a ZIP code, a city, a county, a state or a user-defined polygon.

12. The method of claim 9 wherein including further comprises conducting an auction including the content item and other eligible content items.

13. The method of claim 9 wherein including further comprises serving the content item responsive to the request.

14. The method of claim 9 wherein including further comprises evaluating the content item along with one or more eligible content items using a selection process.

15. The method of claim 14 wherein the selection process is an auction.

16. The method of claim 14 wherein the selection process is a reservation service.

17. A system that provides content items, the system comprising:
a sponsor interface that allows a content sponsor to target a content item to users, wherein the content item is associated with targeting criteria that is based on a location associated with the users and further based on a specified location associated with the content item; and
a content management system that provides content items responsive to received requests, the content management system comprising a request handler enabled to:
receive a request for content from a user;
identify a current location of the user;
determine a distance from the current location to the specified location;
determine when the distance satisfies the targeting criteria associated with the one content item and, when the distance satisfies the targeting criteria, including the one content item in an auction along with other content items responsive to the request; and
provide winning results of the auction responsive to the request.

18. A computer program product tangibly embodied in a computer-readable storage device and comprising instructions that, when executed by a processor, cause the processor to:
receive a request for a content item to be served to a user;
identify one or more content items responsive to the request, where at least one of the content items includes a targeting criteria that is based at least in part on a location associated with the user;
identify a specified location associated with the one content item;
identify a current location of the user;
determine a distance from the current location to the specified location;
determine when the distance satisfies the targeting criteria associated with the one content item and, when the distance satisfies the targeting criteria, including the one content item in an auction along with other content items responsive to the request; and
provide winning results of the auction responsive to the request.

19. A computer program product tangibly embodied in a computer-readable storage device and comprising instructions that, when executed by a processor, cause the processor to:
receive an indication from a content sponsor to create a campaign for presenting content to one or more users responsive to received requests to deliver content;
receive targeting criteria for the campaign including receiving an indication to target content based at least in part on one or more distances of a user from a geographic location associated with the campaign, the targeting criteria including one or more bids for the presentation of content associated with the geographic location, the presentation of the content to occur in response to a request for content from a particular user and when a current location of the particular user is within a certain distance relative to the geographic location;
store the campaign; and
deliver the content to users in accordance with the campaign and responsive to requests for content received from a user with a current location within the certain distance relative to the geographic location.

20. A computer program product tangibly embodied in a computer-readable storage device and comprising instructions that, when executed by a processor, cause the processor to:
receive a request for a content item to be served to a user;
identify a content item from an inventory of content items that is responsive to the request, wherein the content item is associated with targeting criteria that is based on a location associated with the user;
identify a specified location associated with the content item;
identify a current location of the user;
determine a distance from the current location to the specified location; and
determine when the distance satisfies the targeting criteria associated with the content item and, when the distance satisfies the targeting criteria, including the one content item as an eligible content item for providing content responsive to the received request.
